(19) United States
(12) Patent Application Publication
(10) Pub. No.: US 2013/0171482 A1
(43) Pub. Date: Jul. 4, 2013

(54) NICKEL-ZINC RECHARGEABLE PENCIL BATTERY

(71) Applicant: PowerGenix Systems, Inc., La Jolla, CA (US)

(72) Inventors: Jeffrey Phillips, La Jolla, CA (US); Samaresh Mohanta, San Diego, CA (US); Cecilila Maske, San Diego, CA (US)

(73) Assignee: POWERGENIX SYSTEMS, INC., La Jolla, CA (US)

(21) Appl. No.: 13/753,299

(22) Filed: Jan. 29, 2013

Related U.S. Application Data
(63) Continuation-in-part of application No. 12/903,004, filed on Oct. 12, 2010.
(60) Provisional application No. 61/595,955, filed on Feb. 7, 2012.
(60) Provisional application No. 61/251,222, filed on Oct. 13, 2009.

(51) Int. Cl. H01M 2/02; H01M 2/12; H01M 10/28; H01M 10/04; H01M 4/26; H01M 2/16; H01M 4/24

(52) U.S. Cl. CPC H01M 2/022; H01M 2/1686; H01M 2/12; H01M 4/244; H01M 10/0422; H01M 4/26; H01M 10/28
USPC 429/53; 429/167; 429/144; 429/206; 29/623.1; 29/623.2

(57) ABSTRACT

A rechargeable pencil battery has a hollow cylindrical positive electrode including nickel hydroxide; a gelled negative electrode comprising at least one of zinc and a zinc compound; a separator interposed between the hollow cylindrical positive electrode and the gelled negative electrode; and a negative electrode current collector inserted into the gelled negative electrode. Rechargeable batteries of the invention are capable of between about 50 and 1000 cycles from a fully charge state to a fully discharged state at a discharge rates of about 0.5 C or greater, in some embodiments about 1 C or greater. Batteries of the invention have a ratio of length to diameter of between about 1.5:1 and about 20:1, and therefore can be longer than typical commercially available batteries but also include batteries of commercial sizes e.g. AAAA, AAA, AA, C, D, sub-C and the like.

### CROSS REFERENCE TO RELATED APPLICATIONS

This application claims benefit of U.S. Provisional Patent Application No. 61/595,955, filed Feb. 7, 2012, and titled “NICKEL-ZINC RECHARGEABLE PENCIL BATTERY” (Attorney Docket No. PWRGP038P2), which is incorporated herein by reference in its entirety and for all purposes. This application is a continuation-in-part of U.S. patent application Ser. No. 12/903,004, filed Oct. 12, 2010, and titled “CYLINDRICAL NICKEL-ZINC CELL WITH POSITIVE CAN” (Attorney Docket No. PWRGP041), which claims benefit of U.S. Provisional Patent Application No. 61/251,222, filed Oct. 13, 2009, and titled “CYLINDRICAL NICKEL-ZINC CELL WITH POSITIVE CAN” (Attorney Docket No. PWRGP041P), both incorporated herein by reference in their entireties and for all purposes.

### BACKGROUND

This disclosure pertains to nickel-zinc batteries. More specifically, it pertains to compositions, configurations and manufacturing methods for nickel-zinc rechargeable batteries.

Recent economic trends indicate a need for high power and high energy density rechargeable batteries, particularly for applications such as electric vehicles and power tools. Economic trends also indicate a need for inexpensive, fast-charging rechargeable batteries. Certain aqueous batteries employing a nickel hydroxide positive electrode and zinc-based negative electrode meet these needs.

The composition and manufacturing methods of nickel-zinc batteries affect their commercial success. There is a need for lowering the cost and simplifying the manufacturing processes to produce nickel zinc batteries suitable for electric vehicles (EV), plug-in hybrid electric vehicles (PHEV), consumer electronics and other applications.

### SUMMARY

In one aspect, the embodiments herein pertain to a rechargeable pencil battery characterized by: a hollow cylindrical positive electrode including nickel hydroxide; a gelled negative electrode including at least one of zinc metal and a zinc compound; a separator interposed between an interior surface of the hollow cylindrical positive electrode and the gelled negative electrode; a negative electrode current collector in the gelled negative electrode; a battery can housing the cylindrical positive electrode, the gelled negative electrode, the separator and the negative electrode current collector, wherein the battery can includes first end that is open and a second end; and a positive cap affixed to the second end of the battery can. In some embodiments, the ratio of the length of the rechargeable battery to the diameter of the rechargeable battery is at least about 1.5:1, and in certain embodiments is between about 2:1 and about 20:1, between about 1.5:1 and 10:1, or between about 1.5:1 and 5:1. In certain embodiments, the battery diameter is between about 5 and 100 mm. In some embodiments, the ratio of the length of the battery to the diameter of the battery is greater than about 5:1 and the diameter is between about 10 and 100 mm. In other embodiments, the ratio of the length of the battery to the diameter of the battery is greater than about 5.5:1 and the diameter is between about 10 mm and 50 mm. Batteries of this aspect are longer than typical commercially available batteries, however, the embodiments herein also include batteries of commercial sizes e.g. AAAA, AAA, AA, C, D, sub-C and the like. In some implementations, the ratio of the diameter of the hollow of the cylindrical positive electrode to the diameter of the battery is between about 0.4-0.95 (e.g., between about 0.5-0.9, between about 0.6-0.85, or between about 0.6-0.7).

In some implementations, the hollow cylindrical positive electrode is a plurality of stacked annular pellets. The hollow cylindrical positive electrode may include nickel hydroxide and cobalt metal and/or a cobalt compound in certain instances, and it may include a first conductive agent. A first conductive agent may include at least one of nickel, carbon, conductive polymers and conductive ceramics. In certain embodiments, the first conductive agent is in the form of a powder, foam, fiber, or combinations thereof. The hollow cylindrical positive electrode may include a binder, and in some embodiments the binder may include at least one of polytetrafluoroethylene (PTFE), cellulose, carboxymethylcellulose (CMC) and hydroxypropylmethylcellulose (HPMC). Further, the hollow cylindrical positive electrode may include an irrigative agent, and in certain embodiments the irrigative agent includes at least one of alumina, cellulose, and a hydrophilic material. In some embodiments, the annulus of the hollow cylindrical positive electrode (i.e., the difference between the annulus' outer and inner radii) is between about 1.5-2.5 mm thick, or between about 2.1-2.5 mm thick.

The gelled negative electrode may, in certain instances, include a solid mixture combined with a gelling agent, an alkali electrolyte and a second conductive agent. The solid mixture may include zinc and zinc oxide. In certain implementations the solid mixture includes at least one of alumina, cellulose and newsprint. In a specific embodiment, the solid mixture includes between about 0-30% by weight zinc, and between about 65-100% zinc oxide. In some implementations, the solid mixture includes between about 0.5-5% cellulose. The solid mixture may also include between about 0.5-5% alumina. The second conductive agent may include at least one of carbon, titanium nitride, and bismuth oxide in certain embodiments. In some cases, the second conductive agent may occupy up to about 30% of the volume of the gelled negative electrode. In one embodiment, the solid mixture, the gelling agent, the alkali electrolyte and the second conductive agent are combined, in situ in the separator, to form the gelled negative electrode. In an alternative embodiment, the solid mixture, the gelling agent, the alkali electrolyte and the second conductive agent are combined to form the gelled negative electrode and then the gelled negative electrode is introduced into the separator.

The separator is substantially tubular in some implementations. The separator may include a bilayer laminant including a barrier layer and a wicking layer. In some implementations, the barrier layer includes a microporous membrane between about 25-75 μm thick. In certain embodiments, the wicking layer is between about 25-200 μm thick. The separator will typically have a topmost portion. In certain implementations, the topmost portion of the separator is above the topmost portion of the hollow cylindrical positive electrode, which in turn is above the topmost portion of the gelled negative electrode. In a specific example, the topmost portion of the separator is between about 2-5 mm above the topmost portion of the hollow cylindrical positive electrode, which in turn is between about 1-5 mm above the topmost portion of the gelled negative electrode.

The negative electrode current collector may include at least one of brass, copper and steel, and optionally includes a hydrogen evolution inhibitor. The hydrogen evolution inhibitor may include at least one of tin, lead, bismuth, silver, and indium. In certain cases the negative electrode current collector may include a surface area enhancing geometrical element, and these elements may include at least one of fins, mesh, perforations, spirals, zig-zags, ridges, helices, and combinations thereof. In some embodiments there is a negative electrode terminal plate that is electrically connected to the negative electrode current collector. In certain cases, a negative collector disc is in electrical communication with the gelled negative electrode, and the negative collector disc is a substantially flat surface that serves as a negative terminal for the rechargeable battery.

The rechargeable battery may also include an identification tag to uniquely identify the rechargeable battery and allow its number of charge and/or discharge cycles to be monitored. In certain cases the identification tag is a barcode. The second end of the can may contain a vent hole in certain implementations. The vent hole may also be located in the positive cap.

In certain embodiments, a rechargeable pencil battery includes a hollow cylindrical positive electrode including nickel hydroxide; a gelled negative electrode including at least one of zinc and a zinc compound; a separator interposed between the hollow cylindrical positive electrode and the gelled negative electrode; and a negative electrode current collector inserted into the gelled negative electrode. The rechargeable battery is capable of between about 50 and 1000 cycles from a fully charged state to a fully discharged state at a discharge rates of about 1 C or greater. In some embodiments, the rechargeable battery is capable of between about 50 and 1000 cycles from a fully charged state to a fully discharged state at a discharge rate of about 0.5 C or greater. Note that batteries described herein may be suitable for low or high discharge rate applications. For low rate applications (e.g., discharge rates of between about 1/10 C to 1/3 C), batteries of the disclosed implementations can replace more expensive “jellyroll” batteries. Batteries of this aspect have a ratio of the length to diameter of between about 1.5:1 and about 20:1 (e.g., between about 1.5:1 and 10:1, between about 1.5:1 and 5:1, greater than about 5:1 or greater than about 5.5:1), and therefore can be longer than typical commercially available batteries but also include batteries of commercial sizes e.g. AAAA, AAA, AA, C, D, sub-C and the like. In some implementations, the ratio of the diameter of the hollow of the cylindrical positive electrode to the diameter of the battery is between about 0.4-0.95 (e.g., between about 0.5-0.9, between about 0.6-0.85, or between about 0.6-0.7).

Another aspect of the embodiments herein is a rechargeable pencil battery characterized by: a hollow cylindrical positive electrode including nickel hydroxide (optionally including nickel oxyhydroxide), and cobalt metal and/or a cobalt compound; a gelled negative electrode including between 0% and about 30% by weight of zinc, between about 65% and 100% by weight of zinc oxide (that is, percentage by dry weight ingredients, without addition of electrolyte), a gelling agent, an alkaline electrolyte, and optionally at least one of carbon, cellulose, titanium nitride and alumina; a substantially tubular separator interposed between the hollow cylindrical positive electrode and the gelled negative electrode; and a negative electrode current collector in the gelled negative electrode. The rechargeable battery of this aspect is also capable of between about 25 and 1000 full capacity cycles at a discharge rate of about 0.5 C or greater, in some embodiments about 1 C or greater. Batteries of this aspect have a ratio of the length to diameter of between about 1.5:1 and 20:1 (e.g., between about 1.5:1 and 10:1, between about 1.5:1 and 5:1, greater than about 5:1 or greater than about 5.5:1), and therefore can be longer than typical commercially available batteries but also include batteries of commercial sizes e.g. AAAA, AAA, AA, C, D, sub-C and the like. In some implementations, the ratio of the diameter of the hollow of the cylindrical positive electrode to the diameter of the battery is between about 0.4-0.95 (e.g., between about 0.5-0.9, between about 0.6-0.85, or between about 0.6-0.7). In certain embodiments the thickness of the annulus (i.e., the difference between the annulus' outer and inner radii) is between about 1-3 mm thick. The hollow cylindrical positive electrode may also comprise nickel and/or carbon in some implementations.

Certain aspects of the embodiments herein provide methods of making a rechargeable pencil battery. In some cases, the manufacturing methods are similar to that of conventional primary alkaline batteries. In these methods, the positive material is pressed into small annular pellets and then the pellets are introduced into a can or container as a stack. A separator tube is placed inside the cavity thus formed, a gelled negative electrode is introduced in the separator tube. In alternative methods, the positive material is introduced into the can and then pressed into a hollow cylindrical shape prior to, or concurrent with, introduction of the separator. A current collector, for example a brass, stainless steel, or tin coated brass structure, is introduced into the gelled negative electrode.

Various current collector designs may be employed in the nickel-zinc pencil cells described herein. In some such designs, the current collector assumes the shape of a thin rod or “nail.” In some cases, the current collector is welded to a closure, which when used to seal the battery, places the collector proximate the center of the gelled negative electrode. In some implementations, the gelled negative electrode is formed in situ in the separator. In certain embodiments, the negative electrode current collector includes a surface area enhancing geometrical element, for example, fins, mesh, perforations, spirals, coils, helices, zig-zags, ridges, and/or combinations thereof. In some embodiments, the topmost portion of the separator tube is above the topmost portion of the hollow cylindrical positive electrode, which in turn is above the topmost portion of the gelled negative electrode. In a specific embodiment, the topmost portion of the separator tube is between about 4-10 mm above the topmost portion of the hollow cylindrical positive electrode, which in turn is between about 1-10 mm above the topmost portion of the gelled negative electrode. In certain implementations, the negative electrode current collector is attached to a closure used to seal the can and complete the rechargeable battery assembly.

Materials, compositions, configurations and methods of manufacture of batteries of the disclosed implementations as well as other features and advantages are discussed further below with reference to associated drawings.

### BRIEF DESCRIPTION OF THE DRAWINGS

FIG. 1A depicts a method of manufacture of batteries of a disclosed embodiment.

FIG. 1B presents an example of a cell configuration having a positive cell cap and negative bottom of the cell can.

FIG. 2 presents a cross-sectional view of cell can and cap in accordance with certain embodiments.

FIGS. 3A and 3B schematically depict a reinforced can structure.

FIG. 4 depicts certain embodiments in which a can with a flat bottom is used with an attached strengthening.

FIG. 5 presents a process flow for making a rechargeable nickel zinc cell in accordance with certain embodiments.

FIG. 6 depicts cycling data and charge to discharge capacity ratio for 80 cycles of a battery of a disclosed embodiment.

### DETAILED DESCRIPTION

Embodiments described herein concern rechargeable batteries including pencil batteries. Those of skill in the art will understand that the following detailed description is illustrative and not limiting in the range of applications for the disclosed rechargeable pencil batteries.

Battery Design

The present embodiments relate to rechargeable battery technology. For convenience, as the following discussion mentions individual components or features of the batteries of the disclosed implementations, the description will focus on that component or feature as the component or feature is mentioned or in a separate section so that more detail can be given without detracting from the high-level description.

### Ni—Zn Rechargeable Pencil Batteries

Rechargeable batteries of certain embodiments herein are Ni—Zn “pencil” batteries. Particular materials, electrode compositions and methods of their making are described below.

New compositions for high power and high energy density rechargeable batteries are often accompanied by more complex cell configuration and requisite manufacturing requirements. Where these more complex cell configurations are housed in “pencil cell” battery configurations, it is important to meet the needs of the consumer electronics industry, among others. Also, due to the convenient cylindrical shape, non-traditional sized pencil cells find use in non-consumer and/or specialty consumer applications.

Rechargeable batteries of the disclosed embodiments have a cylindrical geometry where the battery length is greater than its diameter; that is, the ratio of the length of the battery to the diameter of the battery is at least about 1.5:1, and in certain embodiments is between about 1.5:1 and about 20:1. In more specific embodiments, the ratio of the length of the battery to the diameter of the battery is between about 1.5:1 and 10:1. In other embodiments, the ratio of the length of the battery to the diameter of the battery is between about 1.5:1 and 5:1. In some implementations, the diameter of batteries is between about 5 mm and about 100 mm. In some embodiments, the ratio of the length of the battery to the diameter of the battery is greater than about 5.5:1 and the diameter is between about 10 mm and 50 mm. In some embodiments, batteries are configured to commercially available sizes, for example AAAA, AAA, AA, C, D, sub-C and the like. In other embodiments, batteries may have diameters substantially the same as conventional commercially available batteries (e.g., within 1% of the diameter of conventional commercially available batteries, or within 5% of the diameter of conventional commercially available batteries) but are longer.

### Methods of Making Ni—Zn Pencil Cells

As described above, the secondary batteries of the embodiments herein are cylindrical or generally cylindrical batteries. Owing to this geometry, methods of making primary batteries are well suited to make secondary batteries of the disclosed implementations, when substituting superior compositions, e.g. for the electrodes and other components to make a rechargeable battery of the disclosed implementations. Particular aspects of some components will be described in more detail in separate sections following this section.

In some embodiments, rechargeable batteries have a hollow cylindrical positive electrode including nickel hydroxide; a gelled negative electrode having at least one of zinc metal and a zinc compound; a separator interposed between the hollow cylindrical positive electrode and the gelled negative electrode; and a negative electrode current collector inserted into the gelled negative electrode. The negative electrode current collector may also be referred to as a negative current collector, a negative collector, a current collector, or a negative collector nail.

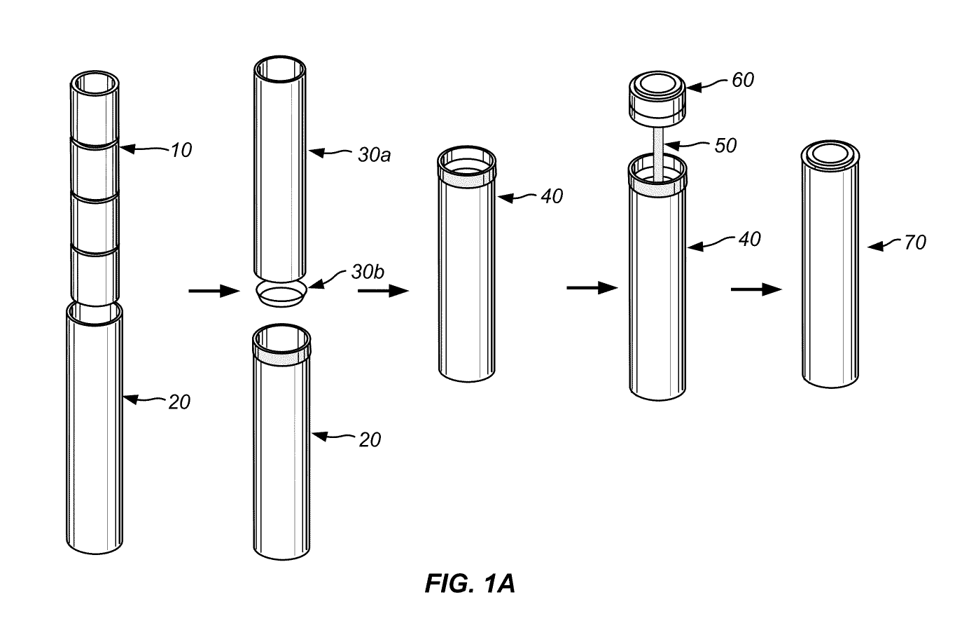

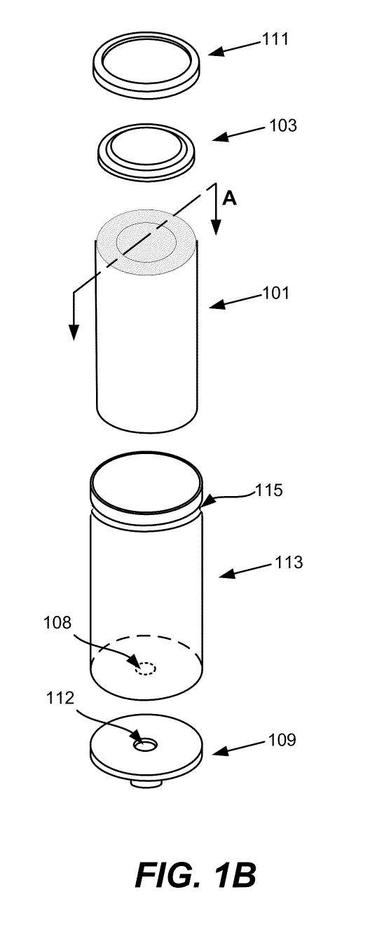

FIG. 1A depicts one method of manufacturing pencil batteries such as those described herein. Referring to FIG. 1A, a positive electrode material (active material and added components) is formed into small annular pellets 10 and the pellets are introduced into a can 20 as a stack. A separator tube, in this example made of tube 30a and bottom cap 30b fused together to form a tube, is placed inside the cavity thus formed. Separators may also be extruded or molded as a single piece, rather than assembled from two pieces as depicted here. The assembly of the pellets 10, the can 20 and the separator is depicted as assembly 40. A gelled negative electrode material is then introduced in the separator tube. The gelled negative electrode material can be pre-formed and introduced to the separator tube. Alternatively, the components of the gelled negative electrode material can be mixed in situ in the separator. In some embodiments, the topmost portion of the separator is above the topmost portion of the hollow cylindrical positive electrode, which in turn is above the topmost portion of the gelled negative electrode. In other embodiments, the topmost portion of the separator is between about 2 mm and about 5 mm (e.g., about 3 mm) above the topmost portion of the hollow cylindrical positive electrode, which in turn is between about 0.5 mm and about 2 mm (e.g., about 1 mm) above the topmost portion of the gelled negative electrode. This arrangement helps prevent zinc from creeping over the separator and reaching the positive electrode.

In alternative methods, rather than a stack of pelleted positive electrode material, the positive material is introduced into the can and then pressed into a hollow cylindrical shape prior to, or concurrent with, introduction of the separator. This can be accomplished, for example, by inserting a dummy rod into the can, compressing the positive electrode material around the rod and then removing the rod. In one example, the dummy rod has the separator on it during compression of the anode material so that once the rod is removed, assembly 40 is achieved efficiently. In some embodiments, the positive electrode is a unitary pre-formed hollow cylindrical body that is inserted into the can.

Referring again to FIG. 1A, a current collector 50, for example a brass, stainless steel, or tin coated brass structure, is introduced into the gelled negative electrode. Aspects of the current collector will be described in more detail in a separate section below. In some cases, the current collector 50, e.g. a “nail”, is affixed to a closure 60 (e.g., by welding), which when used to seal the battery, places the nail in the center of the gelled negative electrode. Once sealed, the assembly of the battery 70 is complete. Following assembly, formation, charge, discharge and recharge can take place.

Below are described various aspects particular to the positive electrode, the gelled negative electrode, the separator, the negative electrode current collector, the can, cell polarity, construction etc. along with formation and charging protocols and exemplary embodiments.

### Positive Electrode Composition and Configuration

The positive electrode material includes an electrochemically active nickel hydroxide of the type described herein. The term “nickel hydroxide” includes, in addition to nickel hydroxide, other nickel-oxygen-containing compounds present during any state of charge. Such compounds include nickel oxyhydroxide and nickel oxide. In addition, it may include one or more additives to facilitate manufacturing, electron transport, wetting, mechanical properties, etc. For example, a positive electrode formulation may include nickel hydroxide particles with or without cobalt hydroxide or cobalt oxide or oxyhydroxide intermixed therewith, together with one or more of the following: zinc oxide, cobalt oxide (CoO), cobalt metal, nickel metal, and a flow control agent such as carboxymethyl cellulose (CMC). Note that the metallic nickel and cobalt may be elemental metals or alloys. The nickel oxide particles and associated cobalt oxide or hydroxide may be formed on the same particle, e.g., through a co-precipitation process or by precipitating the cobalt oxide or hydroxide onto nickel oxide particles. In certain embodiments, the positive electrode has a composition similar to that employed to fabricate the nickel electrode in a conventional nickel cadmium battery or a conventional nickel metal hydride battery.

Other materials may be provided with the positive electrode. Examples of materials that may improve charge efficiency include strontium hydroxide (Sr(OH)₂), barium oxide (BaO), calcium hydroxide (Ca(OH)₂), Fe₃O₄, calcium fluoride (CaF₂), and yttrium oxide (Y₂O₃). The addition of the yttrium oxide and the calcium compounds has been shown to be beneficial for the charge acceptance at higher temperatures. See “Nickel Hydroxide Electrode: improvement of charge efficiency at high temperature” by K. Ohta, K. Hyashi, H Matsuda, Y. Yoyoguchi and Mikoma in The Electrochemical Society proceedings Volume 94-27 (Hydrogen and Metal Hydride Batteries edited by T. Sakai and P. D. Bennett), which is incorporated herein by reference in its entirety.

In certain embodiments, the finished positive electrode contains between about 0-10 weight percent cobalt metal powder, between about 0-10 weight percent of a cobalt compound such as cobalt oxide, cobalt hydroxide, or cobalt oxyhydroxide, between about 0-10 weight percent nickel powder, between about 0-3 weight percent zinc oxide, between 0-1 weight percent of an oxide and/or hydroxide of any of cadmium, yttrium, calcium, barium, strontium, scandium, lanthanide, bismuth, manganese, magnesium.

In addition, the electrode may contain small amounts of an “irrigative” agent such as carboxymethylcellulose (CMC), alumina, cellulose, alumina/silica composites and nylon fibers. In one embodiment, newsprint is used as the irrigative agent. Irrigative agents, when present, are at a concentration between about 1% and about 6% by weight, and in some embodiments between about 2% and about 3% by weight. The irrigative agent helps keep the positive electrode sufficiently wet during cycling. Since the thickness of the electrode may hinder transport of electrolyte to the interior regions of the electrode during repeated cycling, an irrigative agent may be necessary, in sufficient amounts, to ensure good long-term performance. The positive electrode also optionally includes a binder such as Teflon® (generally a fluorinated polyolefin such as PTFE) at a concentration of about 0.1-2% by weight.

Still further, the positive electrode may contain a highly conductive additive such as nickel metal, carbon, conductive ceramics, cobalt metallic powder or cobalt compounds, and conductive polymers. The conductive additive(s) are added in amounts of between about 2% and 8% by volume of the total positive electrode material. The final concentration of conductive additives in the positive electrode is at least about 10% by volume. In some embodiments the final concentration of the conductive additives is about 20% by volume. The conductive material can be in the form of a powder, foam, fiber or combinations thereof. The conductive additive may be necessary to maintain good performance, particularly high rate performance for the relatively thick electrodes (as compared to e.g. a Jellyroll configuration) described herein.

The balance of the positive electrode material is nickel hydroxide (or a modified nickel compound). In certain embodiments, the nickel hydroxide is present in an amount of about 60-95 weight percent. Note that all concentrations and amounts of positive electrode components recited here are based on the dry weight the positive electrode, which does not include electrolyte that infuses the electrode during assembly and operation.

In a specific example, the pasted nickel hydroxide electrode composition is made from about 1% to about 5% by weight Co powder, about 2% to about 10% by weight Ni210 powder together with about 0.4% to about 2% by weight sodium carboxymethyl cellulose (CMC), and about 0.1% to about 2% by weight poly(tetrafluoroethylene) (PTFE). Nickel hydroxide powder makes up the balance.

Various positive electrode components are described in the following documents, each of which is incorporated herein by reference: PCT Publication No. WO 02/039534 (by J. Phillips) (co-precipitated Ni(OH)₂, CoO and finely divided cobalt metal), US Patent Publication No. 2005-0003270 by J. Phillips filed Jul. 26, 2004, US Patent Publication No. 20020192547 by J. Phillips filed Mar. 15, 2002 (fluoride additives), U.S. patent application Ser. No. 12/365,658, filed Feb. 4, 2009 (nickel hydroxide electrode), and U.S. patent application Ser. No. 12/432,639, filed Apr. 29, 2009.

The nickel hydroxide electrode is generally provided on a current conducting substrate such as a nickel foam matrix, although other substrate forms such as foils, perforated sheets, and expanded metals may also be used to fabricate the hollow cylindrical positive electrode. In certain implementations, the nickel foam is provided by Lyrun Co. of China or Vale Canada Limited of Toronto, Canada. In a specific embodiment, nickel foam of density ranging from about 300-500 g/m² is used. In another implementation the range is between about 350-500 g/m². In one example, a nickel foam having a density of about 350 g/m² is used.

Methods of making positive electrodes of the disclosed embodiments include wet and dry processes. Wet processes are described in U.S. patent application Ser. No. 10/921,062, filed Aug. 17, 2004, and incorporated herein by reference. For example, the pasted nickel hydroxide electrode may be made using a mixture of the stabilized nickel hydroxide powder, together with other positive electrode components (e.g., cobalt powder, nickel powder, CMC and PTFE) in a paste. The active material paste is forced into nickel foam and pressed to form a nickel electrode pellets or rings as described above. In other embodiments, the positive electrode is made by a dry process which does not employ substantial water or other liquid. See for example U.S. patent application Ser. No. 11/367,028, filed Mar. 1, 2006 and incorporated herein by reference. The component materials of nickel hydroxide, nickel and cobalt powders may be dry blended together with a suitable binder and introduced into a hopper. In one embodiment, the dry mixture is used to form the cathode pellets as described above. In another embodiment, a continuous strip of foam nickel is drawn through the powder while rotating brushes force the dry material into the foam pores. A compression step can then, for example, press the foam into annular pellets as described above.

The positive electrode of the implementations herein has a hollow, substantially cylindrical shape. As mentioned, the positive electrode can be a one-piece construction, but in some embodiments the positive electrode is constructed by stacking rings of the positive electrode material (which contains active material and other agents as described herein). As described in the experimental example below, many thin rings (i.e., rings that are short along the axis of rotational symmetry) can be used in the stack to achieve the desired electrode height. Alternatively, as depicted in FIG. 1A, a fewer number of taller rings may be used to form the stack.

An important consideration is the width of the rings used to make the positive electrode stack. This width may be important because once the rings are stacked, they form the hollow occupied by the negative electrode. The hollow defines the surface area with which the negative electrode makes electrical contact via the separator. Furthermore, the hollow, together with the separator (which is relatively thin compared to the anode), determines the available volume and thus the maximum amount of negative electrode that can be used in the cell.

Various formulations of both the positive and negative electrode, and their resultant electrical conductivity, require particular positive ring thicknesses to achieve a desired balance of the negative to positive electrical communication surface area, which determines the milliamp-hours (mAH) available per square centimeter of interface area. The positive thickness can be expressed in terms of a relative ratio of the diameter of the hollow to the diameter of the cell. In one embodiment, the relative ratio of the diameter of the hollow to the diameter of the cell is between about 0.4 and about 0.95. In another embodiment, the relative ratio of the diameter of the hollow to the diameter of the cell is between about 0.5 and about 0.9. In yet another embodiment, the relative ratio of the diameter of the hollow to the diameter of the cell is between about 0.6 and about 0.85. In some embodiments, cells have a diameter of between about 5 mm and 100 mm. Thus in one example, for high cycle life and higher discharge rate at high energy density, an AA cell (diameter e.g., 14 mm) will have a cylindrical positive (the difference between the outer radius and the inner radius of the annular electrode) between about 1 mm and about 3 mm thick, in another example an AA cell with have a cylindrical positive between about 1.5 mm and 2.5 mm thick, in yet another example an AA cell with have a cylindrical positive between about 2.1 mm and 2.5 mm thick (relative ratio of the diameter of the hollow to the diameter of the cell is between about 0.6 and about 0.7). In cells with larger diameters, e.g. D or non-traditional sizes, the anode can be thicker due to the higher interfacial area but there will be a power-energy trade off

### Negative Electrode Composition

The gelled negative electrode includes one or more electroactive sources of zinc or zincate ions optionally in combination with one or more additional materials such as conductivity enhancing materials, corrosion inhibitors, wetting (or irrigating) agents, and gelling agents, etc. as described below. When the electrode is fabricated it will be characterized by certain physical, chemical, and morphological features such as coulombic capacity, chemical composition of the active zinc, porosity, tortuosity, etc.

In certain embodiments, the electrochemically active zinc source may include one or more of the following components: zinc oxide, calcium zincate, zinc metal, and various zinc alloys. Any of these materials may be provided during fabrication and/or be created during normal cell cycling. As a particular example, consider calcium zincate, which may be produced from a paste or slurry containing, e.g., calcium oxide and zinc oxide.

If a zinc alloy is employed, it may in certain embodiments include bismuth and/or indium. In certain embodiments, it may include up to about 20 parts per million lead. A commercially available source of zinc alloy meeting this composition requirement is PG101 provided by Noranda Corporation of Canada. The zinc active material may exist in the form of a powder, a granular composition, etc.

In one embodiment, the gelled negative electrode includes a solid mixture combined with a gelling agent and an alkali electrolyte. The solid mixture includes zinc and/or zinc oxide. In one implementation, the solid mixture includes between 0% and about 30% by weight of zinc, and between about 65% and 100% by weight of zinc oxide. The solid mixture, beside the electrochemically active zinc components, may also contain smaller amounts of, e.g., irrigative agents, binders, and the like as described below. The solid mixture is combined with an electrolyte and a gelling agent to form the gelled negative electrode. All “by weight” concentrations of negative electrode components recited herein are provided on the basis of dry components, without added electrolyte.

In addition to the electrochemically active zinc component(s), the gelled negative electrode may include one or more additional materials that facilitate or otherwise impact certain processes within the electrode such as ion transport, electron transport (e.g., enhancing conductivity), wetting, porosity, structural integrity (e.g., binding), gassing, active material solubility, barrier properties (e.g., reducing the amount of zinc leaving the electrode), corrosion inhibition etc.

The conductive agent can constitute up to about 35% of the volume of the gelled negative electrode (in a specific embodiment between about 5% and 30% of the volume. Examples of materials that may be added to the negative electrode to improve electronic conductance include various electrode compatible materials having high intrinsic electronic conductivity. The exact concentration will depend, of course, on the properties of the chosen additive(s). Conductive agents for the gelled negative electrode include carbon, titanium nitride, conductive ceramics such as titanium sub-oxides, bismuth, tin powders or oxides of bismuth and tin (that will convert to the metal during formation). The conductive material can be in the form of a powder, foam, fiber or combinations thereof. In some embodiments, copper foam, optionally coated with tin or zinc, is used as a conductive matrix. Relatively high concentrations of the conductive additive may be necessary to maintain good performance, particularly high discharge rate performance, of the relatively thick negative electrodes described herein.

As with the positive electrode, the negative electrode can benefit from use of an irrigative or wetting agent. In certain embodiments, the concentration of the wetting agent is between about 1% and about 8% by weight, in some embodiments greater than 8% by weight. The irrigative agent helps keep the negative electrode sufficiently wet during cycling. Since the thickness of the gelled negative electrode may hinder transport of electrolyte to the interior regions of the electrode during repeated cycling, an irrigative agent may be necessary, in sufficient amounts, to ensure good long-term performance. Examples of materials that may be added to the negative electrode to improve wetting include cellulose, titanium oxides, alumina, silica, alumina and silica together, etc. Such materials may be provided in the form of fibers, particles, powders, etc. A further discussion of such materials may be found in U.S. Pat. No. 6,811,926, issued Nov. 2, 2004, titled, “Formulation of Zinc Negative Electrode for Rechargeable Cells Having an Alkaline Electrolyte,” by Jeffrey Phillips, which is incorporated herein by reference for all purposes.

Gelling agents for the gelled negative electrode include carboxymethylcellulose, crosslinking-type branched polyacrylic acid, natural gum, CARBOPOL® available from Noveon of Cleveland, Ohio, or the like. Note that while the negative electrode is described herein as a “gelled” electrode, the embodiments are not so limited. The negative electrode may alternatively be provided as a slurry, a paste, a solid mixture, etc.

In some embodiments, the negative electrode includes an oxide such as bismuth oxide, indium oxide, and/or aluminum oxide. Bismuth oxide and indium oxide may interact with zinc and reduce gassing at the electrode. Bismuth oxide may be provided in a concentration of between about 1% and about 10% by weight of a gelled negative electrode formulation. Bismuth oxide, aluminum oxide and/or indium oxide may also facilitate recombination of oxygen. Indium oxide may be present in a concentration of between about 0.05% and about 0.2% by weight of a gelled negative electrode formulation. Aluminum oxide may be provided in a concentration of between about 1% and about 8% by weight of a gelled negative electrode formulation.

In certain embodiments, one or more additives may be included to improve corrosion resistance of the zinc electroactive material and thereby facilitate long shelf life. The shelf life can be critical to the commercial success or failure of a battery cell. Recognizing that batteries are intrinsically chemically unstable devices, steps may be taken to preserve battery components, including the negative electrode, in their chemically useful form. When electrode materials corrode or otherwise degrade to a significant extent over weeks or months without use, their value becomes limited by short shelf life.

Specific examples of anions that may be included to reduce the solubility of zinc in the electrolyte include phosphate, fluoride, borate, zincate, silicate, stearate, etc. Generally, these anions may be present in a negative electrode in concentrations up to about 5% by weight of a negative electrode formulation. It is believed that at least some of these anions may go into solution during cell cycling to reduce the solubility of zinc. Examples of electrode formulations including these materials are included in the following patents and patent applications, each of which is incorporated herein by reference for all purposes: U.S. Pat. No. 6,797,433, issued Sep. 28, 2004, titled, “Negative Electrode Formulation for a Low Toxicity Zinc Electrode Having Additives with Redox Potentials Negative to Zinc Potential,” by Jeffrey Phillips; U.S. Pat. No. 6,835,499, issued Dec. 28, 2004, titled, “Negative Electrode Formulation for a Low Toxicity Zinc Electrode Having Additives with Redox Potentials Positive to Zinc Potential,” by Jeffrey Phillips; U.S. Pat. No. 6,818,350, issued Nov. 16, 2004, titled, “Alkaline Cells Having Low Toxicity Rechargeable Zinc Electrodes,” by Jeffrey Phillips; and PCT/NZ02/00036 (publication no. WO 02/075830) filed Mar. 15, 2002 by Hall et al.

Various organic materials may be added to the negative electrode for the purpose of binding and dispersion. Examples include hydroxylethyl cellulose (HEC), carboxymethyl cellulose (CMC), the free acid form of carboxymethyl cellulose (HCMC), polytetrafluoroethylene (PTFE), polystyrene sulfonate (PSS), polyvinyl alcohol (PVA), nopcosperse dispersants (available from San Nopco Ltd. of Kyoto Japan), etc.

When defining an electrode composition herein, it is generally understood as being applicable to the composition as produced at the time of fabrication, as well as compositions that might result during or after formation cycling, or during or after one or more charge-discharge cycles while the cell is in use (e.g., while powering a portable tool). In certain embodiments, the rechargeable batteries are capable of between about 50 and about 1000 cycles from a fully charged state to a fully discharged state at a discharge rate of about 1 C or greater, or are capable of between about 100 and about 800 cycles from a fully charged state to a fully discharged state at a discharge rate of about 1 C or greater, or are capable of between about 200 and about 500 cycles from a fully charged state to a fully discharged state at a discharge rate of about 1 C or greater. In some embodiments, these cycle ranges are achieved by batteries that discharge from a fully charged state to a fully discharged state at a discharge rate of about 0.5 C or greater.

Various negative electrode components and mixtures within the scope of the implementations herein are described in the following documents, each of which is incorporated herein by reference: PCT Publication No. WO 02/39517 (J. Phillips), PCT Publication No. WO 02/039520 (J. Phillips), PCT Publication No. WO 02/39521, PCT Publication No. WO 02/039534 and (J. Phillips), US Patent Publication No. 2002182501. Negative electrode additives in the above references include, for example, silica and fluorides of various alkaline earth metals, transition metals, heavy metals, and noble metals.

Finally, it should be noted that while a number of materials may be added to the negative electrode to impart particular properties, some of those materials or properties may be introduced via battery components other than the negative electrode. For example, certain materials for reducing the solubility of zinc in the electrolyte may be provided in the electrolyte or separator (with or without also being provided to the negative electrode). Examples of such materials include, but are not limited to, phosphate, fluoride, borate, zincate, silicate, and stearate. Other electrode additives identified above that might be provided in the electrolyte and/or separator include, but are not limited to, surfactants, ions of indium, bismuth, lead, tin, calcium, etc.

### Separators

Typically, a separator will have small pores. In certain embodiments the separator includes multiple layers in a laminate. The pores and/or laminate structure may provide a tortuous path for zinc dendrites and therefore effectively bar penetration and shorting by dendrites. In one embodiment, the porous separator has a tortuosity of between about 1.5 and 10, or between about 2 and 5. The average pore diameter is at most about 0.2 microns, and in some embodiments is between about 0.02 and about 0.1 microns. Also, the pore size is fairly uniform in the separator. In a specific embodiment, the separator has a porosity of between about 35% and 55%. In one implementation of this embodiment, the separator material has about 45% porosity and a pore size of about 0.1 micron.

In a certain embodiments, the separator includes at least two layers (and in one embodiment exactly two layers)—a barrier layer to block zinc penetration and a wetting layer to keep the cell wet with electrolyte, allowing ionic current to flow. This is generally not the case with nickel cadmium cells, which employ only a single separator material between adjacent electrode layers.

As indicated, performance of the cell may be aided by keeping the electrodes wet. Thus, in some embodiments, the barrier layer is located adjacent to the negative electrode and the wetting layer is located adjacent to the positive electrode. This arrangement improves performance of the cell by maintaining electrolyte in contact with the positive electrode. In other embodiments, the wetting layer is placed adjacent to the negative electrode and the barrier layer is placed adjacent to the positive electrode. This arrangement aids recombination of oxygen at the negative electrode by facilitating oxygen transport to the negative electrode via the electrolyte.

The barrier layer is typically a microporous membrane. Any microporous membrane that is ionically conductive may be used. Often a polyolefin having a porosity of between about 30% and about 80% and an average pore size of between about 0.005 and about 0.3 micron will be suitable. In one embodiment, the barrier layer is a microporous polypropylene. The barrier layer is typically about 10 μm and about 100 μm thick, and in some implementations is between about 25 μm and about 75 μm thick.

The wetting (or wicking) layer may be made of any suitable wettable separator material. Typically the wetting layer has a relatively high porosity e.g., between about 50% and about 85% porosity. Examples include polyamide materials such as nylon-based as well as wettable polyethylene and polypropylene materials. In certain embodiments, the wetting layer is between about 25 μm and about 250 μm thick, or between about 25 μm and about 200 μm thick, or between about 75 μm and about 150 μm thick. Examples of materials that may be employed as the wetting material include NKK VL100 (NKK Corporation, Tokyo, Japan), FS2213E or Vilene FV4365 (Freudenberg of Germany), and Scimat 650/45 (SciMAT Limited, Swindon, UK).

Other separator materials known in the art may be employed. As indicated, nylon-based materials and microporous polyolefins (e.g., polyethylenes and polypropylenes) are very often suitable.

Another consideration in the separator design is whether to provide the separator as an assembly of multiple parts, e.g. a tube and a cap or whether the separator is formed as a single unit, e.g. in a tube. In one embodiment the separator is formed by layering the microporous layer and the wicking layer cross wise and forming them into a tube shape via a die or mandrel. If appropriate, the resulting structure can be heat sealed to bond the layers.

### Electrolyte

In certain embodiments pertaining to nickel-zinc cells, the electrolyte composition limits dendrite formation and other forms of material redistribution in the zinc electrode. Examples of suitable electrolytes are described in U.S. Pat. No. 5,215,836 issued to M. Eisenberg on Jun. 1, 1993, which is hereby incorporated by reference. In some cases, the electrolyte includes (1) an alkali or earth alkali hydroxide, (2) a soluble alkali or earth alkali fluoride, and (3) a borate, arsenate, and/or phosphate salt (e.g., potassium borate, potassium metaborate, sodium borate, sodium metaborate, and/or a sodium or potassium phosphate). In one specific embodiment, the electrolyte includes about 4.5 to about 10 equiv/liter of potassium hydroxide, from about 2 to about 6 equiv/liter boric acid or sodium metaborate and from about 0.01 to about 1 equiv/liter of potassium fluoride. A specific electrolyte for high discharge rate applications includes about 8.5 equiv/liter of hydroxide, about 4.5 equiv/liter of boric acid and about 0.2 equiv/liter of potassium fluoride.

The embodiments are not limited to the electrolyte compositions presented in the Eisenberg patent. Generally, any electrolyte composition meeting the criteria specified for the applications of interest will suffice. Assuming that high power applications are desired, then the electrolyte should have very good conductivity. Assuming that long cycle life is desired, then the electrolyte should resist dendrite formation. In many of the present implementations, the use of borate and/or fluoride containing KOH electrolyte along with appropriate separator layers reduces the formation of dendrites, thus achieving a more robust and long-lived power cell.

In a specific embodiment, the electrolyte composition includes an excess of between about 3 and about 5 equiv/liter hydroxide (e.g., KOH, NaOH, and/or LiOH). This assumes that the negative electrode is a zinc oxide based electrode. For calcium zincate negative electrodes, alternate electrolyte formulations may be appropriate. In one example, an appropriate electrolyte for calcium zincate has the following composition: about 15% to about 25% by weight KOH and about 0.5% to about 5.0% by weight LiOH.

In some cases, the electrolyte may contain a relatively high concentration of phosphate ion as discussed in U.S. patent application Ser. No. 11/346,861, filed Feb. 1, 2006 and incorporated herein by reference for all purposes.

### Negative Electrode Current Collector

The rechargeable batteries of the disclosed implementations have a negative electrode current collector positioned in the gelled negative electrode. Considerations are made to maximize current collecting efficiency while taking into account manufacturing cost. In one implementation, the negative electrode current collector is made of at least one alloy of brass, copper, steel, and combinations thereof. In some embodiments, the negative current collector optionally includes a hydrogen evolution inhibitor. Hydrogen evolution inhibitors of the embodiments herein include at least one of tin, lead, bismuth, silver, and indium. Some of the materials used in the current collector may form only a surface coating. In such embodiments, the coating may be applied by plating (e.g., through electroplating and/or electroless plating), painting, spraying, and the like.

Typically, but not necessarily, the negative electrode current collector is configured as a “nail” type structure, inserted into the gelled negative electrode. The “nail” is a narrow, substantially cylindrical shape, optionally tapered toward the end furthest into the gelled electrode.

The balance between current collecting efficiency and the amount of active material in the gelled negative electrode is important. When the current collector is substantially cylindrical in shape, the diameter and the length of the current collector actually in contact with the gelled negative electrode determine the interfacial surface area between the current collector and the gelled negative electrode. In some implementations, the diameter of the current collector is between about 5% and about 20% of the diameter of the battery, or between about 10% and about 15% of the diameter of the battery, or between about 10% and about 12% of the diameter of the battery. The length of the current collector actually in contact with the gelled negative electrode therefore is an important parameter. Given the current collector diameters described above, in some embodiments, the length L¹ of the gelled negative electrode in the separator (residing in the hollow cylindrical positive electrode) and the length L² corresponding to the portion of the negative electrode current collector positioned in the gelled negative electrode satisfy the relation: 0.5≦L²/L¹≦0.95, or 0.6≦L²/L¹≦0.9, or 0.75≦L²/L¹≦0.85.

In other embodiments, it is desirable to change the shape of the negative electrode current collector to increase surface area and thereby increase current collector efficiency. In some embodiments, the negative electrode current collector includes a surface area enhancing geometrical element. Thus, the current collector may include fins, mesh, perforations, spirals, coils, zig-zags, ridges, and combinations thereof. In one embodiment the current collector is a perforated plate or cylinder. In another embodiment the current collector is a rigid mesh, formed by, for example, compressing a metal or alloy mesh into a current collector. In another embodiment the current collector is a perforated plate or cylinder (to provide rigidity) with a mesh or foam on and/or inside (in the case of the cylinder) the perforated metal surface. With such embodiments that increase surface area, the diameter of the current collector becomes less important, but the length of the current collector inserted into the gelled electrode remains an especially important variable to maximize the amount of gelled electrode available for charging, discharging and recharging. Thus, current collectors with increased surface area (relative to a simple cylindrical shape) due to the surface area enhancing geometrical element may be of smaller average diameter than those described above for substantially cylindrical current collectors.

Finally, the batteries of the disclosed implementations may include a negative electrode terminal plate electrically connected to the negative electrode current collector. The terminal plate may be integrated into the closure 60 as described in relation to FIG. 1A.

### Formation and Charging

Formation of cells refers to the initial electrical charging. The formation of batteries using the improved batteries of the implementations herein may be carried out, for example, using methods described in U.S. patent application Ser. No. 12/432,639, filed Apr. 29, 2009, by J. Phillips, entitled “Nickel Hydroxide Electrode for Rechargeable Batteries,” which is incorporated by reference herein for all purposes.

Charging of the nickel-zinc batteries may follow previously reported charging techniques such as those described in U.S. Pat. No. 6,801,017, by J. Phillips, entitled “Charger for rechargeable nickel-zinc battery,” which is incorporated by reference herein for all purposes.

Alternatively, the nickel-zinc batteries can be charged using a constant voltage phase, which may be preceded by a constant current phase and/or followed by a post voltage phase. Such methods are described in U.S. patent application Ser. No. 12/442,096, filed Mar. 19, 2009, by J. Phillips, entitled “Charging methods for Nickel-Zinc Battery Packs,” which is incorporated by reference herein for all purposes. Such methods include a two- or three-stage charging regime that starts with a constant current phase until the cell reaches a temperature compensated voltage level. From there, the charging transitions to a constant voltage stage. One of ordinary skill in the art would understand that with particular cell arrangements as described herein, charging methods may be adapted to particular cell configurations and compositions.

### Polarity, Can and Cell Construction

The embodiment shown in FIG. 1A has a polarity reverse of that found in a conventional pencil cell, in that the cap is negative and the can is positive. In conventional power cells, the polarity of the cell is such that the cap is positive and the can or vessel is negative. That is, the positive electrode of the cell assembly is electrically connected with the cap and the negative electrode of the cell assembly is electrically connected with the can that retains the cell assembly. Although in the embodiment described in relation to FIG. 1A, the polarity of the cell is opposite of that of a conventional cell (i.e. the negative electrode is electrically connected with the cap and the positive electrode is electrically connected to the can), it should be understood that in certain embodiments, the polarity remains the same as in conventional designs—with a positive cap. This is accomplished by, for example, modifying the closure 60, as described in relation to FIG. 1A, so that it mimics the bottom of a can, while modifying the bottom of the can to mimic the shape of the cap. One of ordinary skill in the art would appreciate that the conventional polarity can also be achieved by other means, for example, transposing the location of the positive electrode and gelled negative electrode, and using the can for negative electrode current collection, etc.

The can is the vessel serving as the outer housing or casing of the final cell. In conventional cells, where the can is the negative terminal, it is typically nickel-plated steel. As indicated, in the present embodiments the can may be either the negative or positive terminal. In embodiments in which the can is negative, the can material may be of a composition similar to that employed in a conventional nickel cadmium battery, such as steel, as long as the material is coated with another material compatible with the potential of the zinc electrode. For example, a negative can may be coated with a material such as copper to prevent corrosion. In embodiments where the can is positive and the cap is negative, the can may be a composition similar to that used in convention nickel-cadmium cells, typically nickel-plated steel.

In some embodiments, the interior of the can may be coated with a material to aid hydrogen recombination. Any material that catalyzes hydrogen recombination may be used. An example of such a material is silver.

One example of a cell configuration having a positive cap and negative bottom of the can is depicted in FIG. 1B. FIG. 1B shows an exploded view of a nickel zinc cell in accord with the disclosed embodiments. A cylindrical electrode assembly 101 (sometimes also referred to as an assembly, cylindrical positive electrode assembly, positive and negative electrode assembly, or cylindrical assembly) is positioned inside a can 113 or other containment vessel. Assembly 101 includes an outer positive electrode and an inner zinc electrode (e.g., a gelled electrode) as described above. The can may be plated on the inside with, e.g., tin to aid in electrical conduction. A negative electrode current collector disc 103 (e.g. copper, optionally plated with e.g. tin) is attached or otherwise is in electrical communication with the cylindrical assembly 101 once the cell is assembled. In one embodiment, collector disc 103 is attached to a nail-type current collector as described above in the context of FIG. 1A in a manner analogous to closure 60. The negative collector disc functions as the external negative terminal, with the negative collector disc electrically connected to the negative electrode. The positive electrode will be in electrical communication with the inside base and/or sides of the can.

A portion of a flexible gasket 111 rests atop the negative collector disk and a portion also rests on a circumferential bead 115 provided along the perimeter in the upper portion of can 113, proximate to the cap 109. The gasket 111 serves to electrically isolate negative collector disc 103 from can 113.

After positive and negative electrode assembly 101 is inserted in the can, the vessel is sealed to isolate the electrodes and associated electrolyte from the environment typically by a crimping process using the portion of the can above bead 115 and crimping that annular portion of can 113 inward and over the top portion of gasket 111 and a circumferential portion of negative collector disc 103, sealing the can shut.

Battery can 113 is the vessel serving as the outer housing or casing of the final cell. In conventional cells, where the can is the negative terminal, it is typically nickel-plated steel. In conventional cells, the can may be either the negative or positive terminal. When the can is positive, the vent cap is on the negative pole; when the can is negative, the vent cap is on the positive pole, i.e., a normal polarity cell. That is, in conventional cells the vent cap is typically part of the component that seals the open end of the can.

The disclosed embodiments utilize a positive can and a venting cap at the positive pole, thus achieving a normal polarity cell with a positive can. An aperture in the base of the can is sufficiently aligned with an aperture in a vent cap that is attached to the base of the can. This configuration maintains the vent on the positive terminal for maximum resistance to electrolyte creep which is more prevalent at the negative pole compared to the positive pole. As mentioned, the electrode assembly 101 is inserted into the can and the negative terminal of the cell is connected to a current collector disc that is crimped, with an intervening gasket to electrically isolate the disc from the can during cell closure. The disc can be readily plated or coated with materials that inhibit the evolution of hydrogen without the difficulty that is associated with the uniform plating of the can interior with such materials. This cell configuration and methods of manufacture thereof provide at least the following advantages: 1) the tendency of the negative electrode to gas is reduced because there is less surface area contact with plated materials such as the can interior, 2) the tendency for the electrolyte to leak through the vent via a creepage mechanism is reduced because the vent is located on the positive terminal, 3) there is no need to plate the can interior with hydrogen inhibiting materials, 4) vent operation is more reproducible because the vent assembly is not subject to the stress of the crimping operation, 5) cost savings due to less materials used (as explained in more detail below), and 6) cost savings due to simpler design and the correspondingly lessened manufacturing demands.

One aspect of this disclosure is a rechargeable nickel zinc cell, including, i) an electrode assembly including a nickel positive electrode, a zinc negative electrode, and at least one separator layer disposed between the nickel positive electrode and the zinc negative electrode; ii) a can in electrical communication with the nickel positive electrode, the can including an aperture at the base of the can; iii) a vent cap affixed to the base of the can and in electrical communication with the can, the vent cap configured to vent gas from the rechargeable nickel zinc cell via the aperture; and iv) a negative collector disc in electrical communication with the zinc negative electrode and electrically isolated from the can, the negative collector disc configured as a closure to the open end of the can.

In this application, the term “can” refers to a battery can, generally but not necessarily, a metal can, e.g. steel or stainless steel. Typically, but not necessarily, the can is plated with nickel. Other can designs would suffice, e.g., a polymer based can that is coated with an electrically conductive material would be appropriate in some embodiments. Also, the term “base of the can” refers to the closed end (or vented end when it includes an aperture) or the battery can's “bottom” (although the embodiments are not limited to any such orientation constraints). In one embodiment, the can is nickel plated steel.

Again referring to FIG. 1B, the assembly is less complicated than conventional rechargeable cells. First, conventional rechargeable cells often have both a negative and a positive collector disc that serve as interior terminals. The cell in FIG. 1B has only a negative collector disc serving as an external terminal. A positive current collector is not needed because direct contact may be made between the positive electrode and the base and/or sides of the can.

Also, there is no need for a welded tab to make electrical connection from the negative electrode to the negative collector disk or the base of the can. In FIG. 1B, the battery assembly as oriented has the negative electrode substrate within the hollow formed by the positive electrode substrate. In this implementation, the positive electrode of the cell assembly is electrically connected with the cap and the negative electrode of the cell assembly is electrically connected with the sides or bottom of the can that retains the cell assembly.

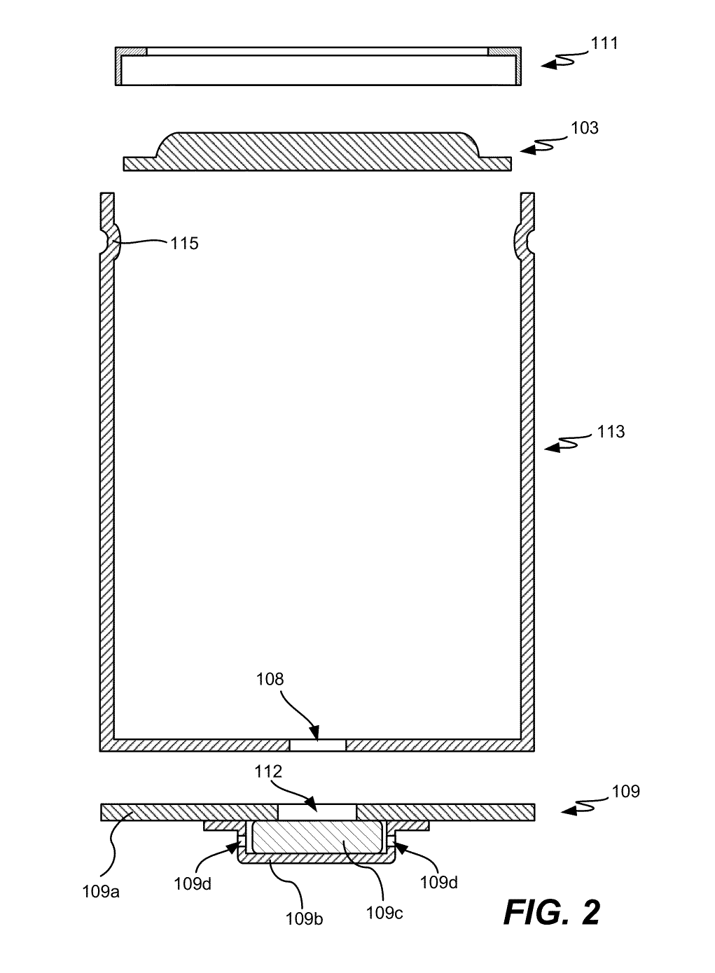

Turning to FIG. 2, can 113 has an aperture 108 at the base of the can (depicted here as the bottom of the can). The cylindrical positive electrode assembly 101 is inserted into the can, and negative current collector 103 is placed atop the cylindrical positive electrode assembly in the can. In one embodiment, the negative collector is a metal disc, e.g. a copper or brass disc, coated with a hydrogen evolution resistant material. In one embodiment, the hydrogen evolution resistant material includes at least one of a metal, an alloy and a polymer. In another embodiment, the hydrogen resistant material includes at least one of tin, silver, bismuth, brass and lead. In yet another embodiment, the hydrogen resistant material includes an optionally perfluorinated polyolefin, in a more specific embodiment, Teflon™ (a trade name by E.I. Dupont de Nemours and Company, of Wilmington Delaware, for polytetrafluoroethylene). In another embodiment, the negative collector is a nail, as described above.

Current collector 103 is configured to make electrical communication with the zinc negative electrode, typically via the nail or other negative current collector. In one embodiment, which can be employed with respect to any of the embodiments above, electrical communication between the negative collector disc and the zinc negative electrode is made via direct contact between the negative collector disc and the negative electrode current collector. In a specific embodiment, the negative electrode current collector comes in direct contact with the negative collector disc. In embodiments where the negative current collector disc is coated with a non-electrically conductive material, e.g. the hydrogen evolution resistant material, the nail or other current collector may be configured to pierce the non-electrically conductive material upon assembly of the cell so as to establish electrical communication.

Negative current collector disc 103 serves as a closure element for can 113 once the cylindrical electrode assembly 101 is sealed in the can. In order to electrically isolate the negative current collector from the can (which is positive due to electrical communication (in this example via direct contact) with the positive substrate of the electrode assembly), gasket 111 is placed between the can and current collector prior to crimping the can shut to seal the cylindrical electrode assembly in the can.

As mentioned, in this example the positive electrode makes direct contact with the end of the can with aperture 108. Electrolyte can be introduced into the can prior to sealing the cylindrical electrode assembly in the can or after the can is sealed. The electrolyte can be introduced to the can via aperture 108.

Vent cap 109 is attached, e.g. welded, to the end of the can having aperture 108. Aperture 108 is aligned sufficiently with aperture 112 in the vent cap to allow gas to vent through the adjoining apertures. More detailed description of vent caps suitable for the disclosed implementations are included in the section specific to vent caps below.

Venting Cap

Although the cell is generally sealed from the environment, the cell may be permitted to vent gases from the battery that are generated during charge and discharge. Thus in reference for example to FIG. 1B, cap 109, although depicted generically, is a venting cap. A typical nickel cadmium cell vents gas at pressures of approximately 200 pounds per square inch (psi). In some embodiments, a nickel zinc cell is designed to operate at this pressure and even higher (e.g., up to about 300 psi) without the need to vent. This higher pressure venting may encourage recombination of any oxygen and hydrogen generated within the cell. In certain embodiments, the cell is constructed to maintain an internal pressure of up to about 450 psi or even up to about 600 psi. In other embodiments, the nickel zinc cell is designed to vent gas at relatively lower pressures. This lower pressure venting may be appropriate when the design encourages controlled release of hydrogen and/or oxygen gases without their recombination within the cell.

Some details of the structure of the vent cap are found in the following patent applications which are incorporated herein by reference for all purposes: PCT/US2006/015807 filed Apr. 25, 2006 and PCT/US2004/026859 filed Aug. 17, 2004 (publication WO 2005/020353 A3.

FIG. 2 is a cross section showing gasket 111, negative current collector 103, can 113, and vent cap 109 in an exploded view. Cells will include these components, along with the cylindrical electrode assembly (not depicted). This simple and elegant design, as mentioned, addresses many drawbacks associated with more complex configurations. The design components depicted in FIG. 2, along with the cylindrical electrode assembly and electrolyte, are combined to make an improved rechargeable nickel zinc cell. For assembly, the cylindrical electrode assembly is introduced into can 113 with the negative electrode occupying the hollow space defined by the inside radius of the cylindrical positive electrode. Next, negative current collector disc 103 is introduced into can 113 atop the cylindrical electrode assembly, where electrical connection is made either directly with the negative current collector nail or via, for example, a metal tab welded to the substrate. Gasket 111 is introduced over and around negative current collector 103, followed by crimping the can at the open end, for example above circumferential indentation 115 to seal the can, while insulating the can from negative current collector disc 103 via interposed gasket 111. Vent cap 109 is attached, e.g. welded, to can 113 so that there is some overlap with apertures 108 and 112 to allow venting of gas from the can through the vent mechanism (described below) of vent cap 109. Vent cap 109 can be attached prior to insertion of the cylindrical electrode assembly and sealing the can, and in one embodiment, this is the order of assembly.

FIG. 2 shows more detail of vent cap 109. The vent cap may include a base disc 109a and a cap 109b, each made of conductive materials described above in the vent section. Cap 109b is affixed to base disc 109a and houses septum 109c, which is made of an elastomeric material that allows gas to vent via apertures 108 and 112 once the cell is assembled. When sufficient pressure is reached, gas passes between septum 109c and base disc 109a and vents through one or more apertures 109d, in this example on the side of cap 109b. Depending on the material used for the septum and the pressure applied by the cap which holds down the septum, pressures such as those described above in the vent section can be maintained and appropriately vented without undue leakage of electrolyte, especially when the cells are in starved configuration as described above.

Reinforced Can

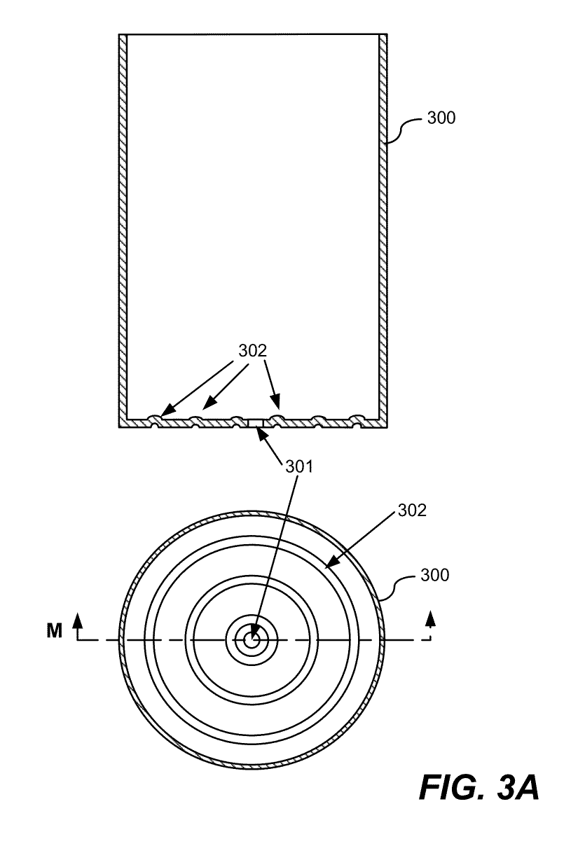

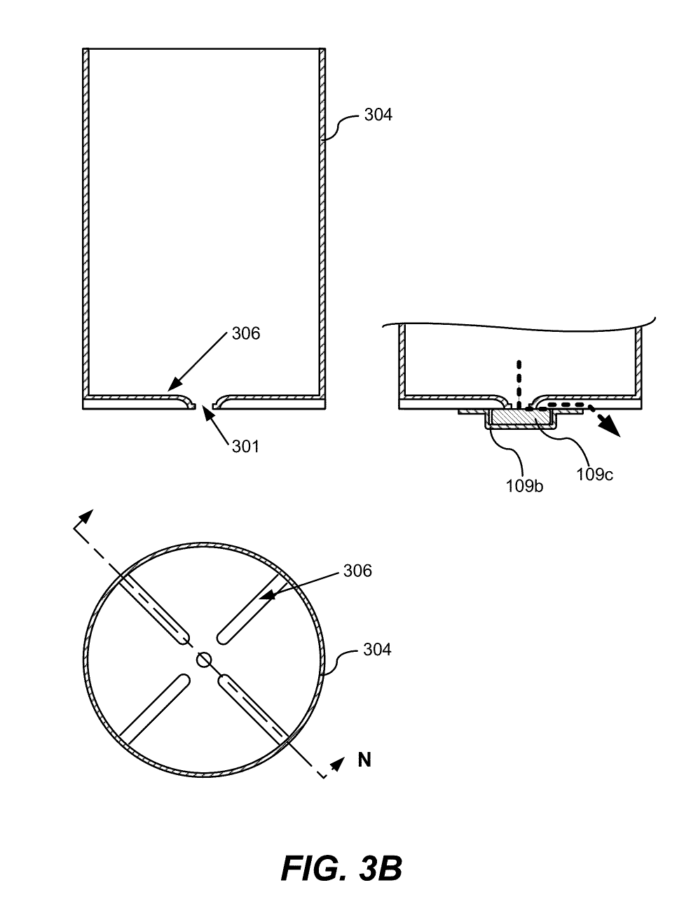

In some embodiments the battery can is reinforced to provide additional rigidity as against shape change and other forces the cell encounters. In one embodiment, the can is thicker at the base than at the sidewall. In certain other embodiments, the can is of sufficient thickness to withstand forces exerted on the can, for example, shape change and/or gas pressure. In a specific embodiment, the can is capable of withstanding pressures up to about 500 or even 600 psi, assuming that the vent does not open. In another embodiment, the base of the can is reinforced. FIG. 3A depicts one example of a reinforced battery can. Can 300 has annular ridges, 302, pressed into the material used to construct the can. The top rendering is length-wise (as indicated by cut M) cross-section of can 300 and the bottom rendering is a top view looking down into can 300. For example, if steel is used for the can, these ridges can be made as part of a stamping process that produces the can. In another example, if the can is made of a polymeric material, the ridges can be constructed as part of a blow-molding process used to make the can. Two-piece cans are within the scope of the disclosed embodiments, that is, for example, a ridged bottom made of metal can be fused with a polymeric tube to construct a battery can analogous to 300.

FIG. 3B also depicts reinforced can 304. Can 304 has ridges, 306, in the base. The top left cross section depicts a cut along line N. The bottom left rendering is a top view looking down into can 304. These ridges are another configuration for imparting rigidity to the base of the can. One of ordinary skill in the art would appreciate that combinations of such structures are within the scope of the implementations herein. For example, ridges 306 may be combined with one or more circular ridges like ridges 302 in can 300. In another example, the base of the can has ridges in a waffle pattern or the like. In this example, each of cans 300 and 304 are shown with an aperture, 301, at the base, but this is not limiting (supra).

In one embodiment, ridges as described in relation to FIGS. 3A and 3B are used in conjunction with a current collecting disk. In one embodiment, the current collecting disk is a metal foam. In one embodiment, the current collecting disk is nickel foam. In this embodiment, the nickel foam compresses to conform to the shape of the ridges, so that it does not take up substantially more volume than is necessary. That is, the foam occupies the spaces between the ridges without being compressed, since the cylindrical electrode assembly lies against the top edge of the ridges. In one embodiment, the ridges, whether employed in conjunction with a nickel foam current collector disk or not, are sharp at the top so that they bite into the cylindrical electrode assembly. In another embodiment, the ridges and/or the bottom of the can is coated with nickel plating.

One of ordinary skill in the art would appreciate that the ridge configurations in FIGS. 3A and 3B allow attachment of the vent cap to the bottom of the can while also not interfering with the vent mechanism. For example, the vent caps as described in relation to FIG. 2 would work on can 300. This is because there are flat surfaces of sufficient area on the bottom of can 300 to make a seal with the septum of the vent cap and/or the base plate 109a of the vent caps. Where ridges 306 form trenches in the bottom of the can 304, it may be necessary to use a vent configuration for vent cap 109 to ensure that venting only occurs via the vent mechanism and not via the trenches.

In one embodiment, a vent mechanism uses these trenches as a passage for venting. In this embodiment, a vent cap is attached, for example spot welded, to the bottom of can 304. This is depicted in the top right rendering in FIG. 3B which shows only the bottom portion of can 304 with a cap 109b spot welded (not shown), for example, to the flat surfaces on the bottom of can 304 between the trenches formed by ridges 306 in the base of the can. Gas can vent as depicted by the heavy dashed arrow. In other words, the gas may vent through the aperture and between septum 109c and the bottom of the can, then through the trenches and out.

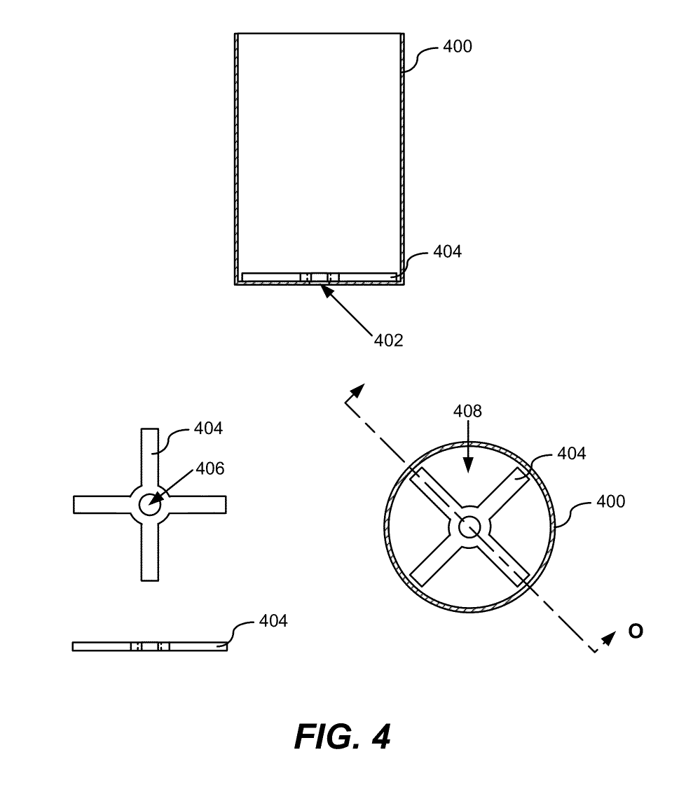

In other embodiments, a can with a flat bottom is used but a strengthening member is attached to the bottom (inside) of the can. FIG. 4 depicts one such embodiment. The top cross section depicts a cut along line O. Can 400 has a strengthening member, 404, attached, for example welded, to the inside bottom of the can. The bottom left rendering in FIG. 4 shows that member 404 has four arms and a center hole, 406. The center hole is configured to register with aperture 402 in the base of the can so that gas can vent through it. The bottom right rendering in FIG. 4 shows a top view of can 400 with member 404 in the base of the can. The thickness of the strengthening member need only be sufficient to reinforce the base of the can to withstand forces on the base of the can such as shape change in the cylindrical electrode assembly and/or gas pressure prior to venting. Depending on the material, member 404 can be as thin as a millimeter and as thick as a few millimeters. Member 404 need not have the configuration shown in FIG. 4, for example, it can be annular, have differing numbers of arms, etc., the member in FIG. 4 is only one variation of many possible. The member has a rigid and relatively flat body (to conserve volume in the cell) that imparts reinforcement to the base of the battery can. In the example shown, the areas, 408, between the arms of the member can be occupied with, for example, nickel foam. In one embodiment, the member is used in conjunction with nickel foam, analogous to the ridges in FIGS. 3A and 3B, the nickel foam compresses between the cylindrical electrode assembly and member 404 but fills the spaces 408 and is sandwiched between the base of the can and the electrode assembly in these spaces. Preferably, member 404 is made of a rigid material and is conductive. Member 404 can be, for example, made of steel coated with nickel, or titanium. Venting mechanisms as described herein are welded or otherwise attached to the bottom of a can so configured with such a strengthening member.

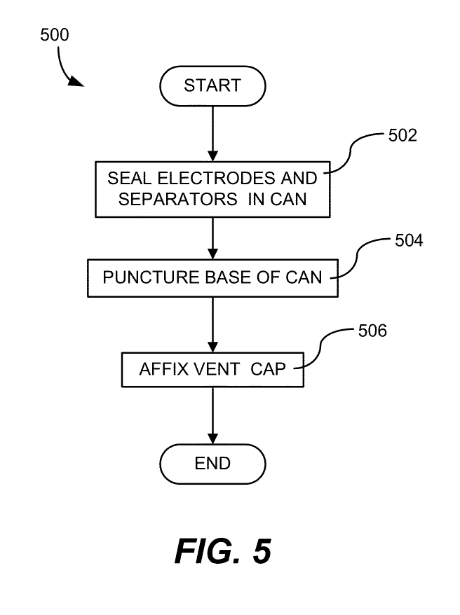

In the broadest sense, as depicted in the process flow 500 of FIG. 5, one embodiment is a method of making a rechargeable nickel zinc cell, the method including: 502) sealing an electrode assembly, including a nickel positive electrode, a zinc negative electrode, and at least one separator layer disposed between said nickel positive electrode and zinc negative electrode, in a can such that the nickel positive electrode is in electrical communication with the base and the body of the can and the zinc negative electrode is in electrical communication with a negative current collector at the other end of the can and electrically isolated from the can; the negative current collector configured as a closure to the open end of the can; 504) puncturing the battery can at the base of the can, thereby making an aperture in the base of the can; and 506) affixing a vent cap at the base of the can; the vent cap configured to vent gas from the rechargeable nickel zinc cell via the aperture. Electrolyte is introduced into the can prior to sealing, or after sealing via the aperture. The process flow elements do not have to be performed in the order depicted, for example the base of the can may be punctured, the vent cap can be attached to the can, and then the electrode assembly is sealed in the can as described. In another embodiment, the electrode assembly is inserted, the can sealed and then the can is punctured to make the aperture. One embodiment is a battery assembly, including an electrode assembly as described herein, sealed in a battery can as described herein, where the battery can is not punctured and, for example, there is no electrolyte or the electrode assembly is in a starved state. Such assemblies can be stored and/or shipped for eventual puncture, addition of electrolyte, and attachment of a vent assembly, for example, as described herein.

Also, it is desirable, although not necessary, to plate the interior of the can with, e.g., nickel. If the cylindrical electrode assembly is sealed in the can and the can is subsequently punctured to form an aperture as described in the previous embodiment, there may be a small portion of the can at the site of the puncture that is not protected with nickel. Also, in some cases is it difficult to plate the interior of the can effectively. In embodiments described herein, the positive electrode is on the outside of the cylindrical electrode assembly, and therefore, for example when the can is steel, iron degradation products from the can do not significantly interfere with the positive electrode function.

In some embodiments however, it is desirable to start with a preformed aperture in the can, then plate the can with a protective agent, for example nickel. In this way there is no portion of aperture 108, and hopefully the interior of the can, that is not protected with nickel. In these embodiments, process operation 504 would be absent from the process flow. Thus another embodiment is a method of making a rechargeable nickel zinc cell, the method including: 502) sealing an electrode assembly, including a nickel positive electrode, a zinc negative electrode, and at least one separator layer disposed between said nickel positive electrode and zinc negative electrode, in a can such that the nickel positive electrode is in electrical communication with the base and the body of the can and the zinc negative electrode is in electrical communication with a negative current collector at the other end of the can and electrically isolated from the can; the can including an aperture in the base of the can; the negative current collector configured as a closure to the open end of the can; and 506) affixing a vent cap at the base of the can; the vent cap configured to vent gas from the rechargeable nickel zinc cell via the aperture. Again, process flow operations 502 and 506 can be performed in reverse order as well.

In one embodiment, which can be employed with respect to any of the embodiments above, the can is nickel plated steel. In another embodiment, the negative collector is a metal disc coated with a hydrogen evolution resistant material, e.g., at least one of a metal, an alloy and a polymer. Specific examples of these materials are described above and are included in the embodiments herein. The negative collector, for example, can be a steel, brass or copper disk coated with at least one of tin, silver, bismuth, brass, zinc and lead. In one example the disc is brass or copper coated with tin and/or silver. In one embodiment, at least a portion of the disc is coated with a polymer, for example, Teflon. In another embodiment, the negative collector is a nail as described above.

Rechargeable Nickel Zinc Batteries in Primary Cell Applications

In certain embodiments, nickel zinc battery cells of the types described herein are used in consumer electronics applications or other applications where primary cells conventionally dominate the market. Example such applications include toys, flash lights, some games, etc. For such applications, a rechargeable nickel zinc battery as described herein may be configured to operate like a conventional primary cell. In one approach, when such cell fully discharges, its user returns it to a recharging station assisted with the vendor of the cell or another entity. At the recharging station, the secondary nickel zinc battery is recharged and then re-vended for a fresh application. For such applications, the rechargeable nickel zinc batteries must be made relatively economically, e.g., on the order of one dollar or less per cell. Further, the cells must be able to recharge at least a modest number of times. For example, the number of charge discharge cycles that the battery can undergo may be at least about 10, or at least about 20, or at least about 25, or at least about 50, or at least about 100.

In order to track the life of the battery, and hence the number of times it can be recharged and re-vended, the battery may be equipped with an identifier such as a barcode or RFID tag that is read each time the battery is submitted for recharging. After the battery has been used for its maximum allotted number of charge cycles, it is disposed of.

Recharging stations for the batteries may be automated or manual. In the case of an automated recharging operation, a vending machine or similar device is provided for users to return their discharged nickel zinc batteries. Such devices may be configured to allow the user to insert the battery, whereupon it is saved for recharging or automatically recharged in the device. In some implementations, upon insertion of the battery into the device, the device credits the user for a further battery purchase. In some cases, the device is configured to dispense a newly recharged battery upon insertion of an appropriate amount of cash or credit.

In a manual recharging station, the recharge station is staffed by one or more employees who are responsible for receiving the discharge batteries and positioning them in an appropriate recharge apparatus. In both the manual and automated systems, the system must determine before each recharge whether or not the battery is to be disposed of or recharged. For this function, the system may check battery's identifier to determine how many charge-discharge cycles it has undergone.

In certain embodiments, a large-scale recharging apparatus is employed. Such apparatus may be able to simultaneously recharge tens or hundreds of nickel zinc batteries. For example, large scale recharging may be done in a parallel arrangement where the voltage is maintained between about 1.89-1.94V, at about 25° C.

In certain embodiments, recharging algorithms are employed for the batteries having designs as described herein. In nickel-zinc batteries having designs as presented herein, it may be challenging to ensure mass transfer is occurring quickly enough to support rapid recharging of the battery cells. This is because some of the negative electrode material is located relatively large distances away from the positive electrode material and vice versa. To address this and/or possibly other challenges, recharge algorithms may employ a relaxation stage in which the charge potential or current is temporarily relaxed after charge has proceeded for a period of time in order to allow sufficient time for appropriate levels of mass transfer within the electrodes. Such relaxation periods may be performed once, twice, three times, or more times during the course of a battery charge.

In certain embodiments, the recharge rate of nickel zinc batteries as described herein is between about C/10 to C/2.

Experimental

A battery cell, sub-C size, was made by placing 70 preformed 0.4 mm thick positive electrode material rings into a can, and then introducing a separator into the hollow formed by stacking the rings. The positive electrode material was made of 91% commercially available Co³⁺ coated Ni(OH)₂ from CRI (Changsha Research Institute, Yuelu, Changsha, Hunan, China), 8% Ni, 0.13% PTFE and the remainder was CMC binder. The separator was a laminated system consisting of a layer of microporous material and a layer of wicking material preformed into a tube. A negative gelled electrode material was placed in the separator tube. The negative material was a pre-gelled mixture of ZnO powder 60%, Zn particles 30%, 4% Alumina, 4% PTFE and 2% Bi-oxide. A brass nail welded to a closure is placed on top of the can, such that the nail (current collector) is in the center of the negative gelled electrode material. The closure is then crimped to the can with insulation such that the positive (can) and negative electrode terminal could not touch. The battery thus formed was then performance tested.

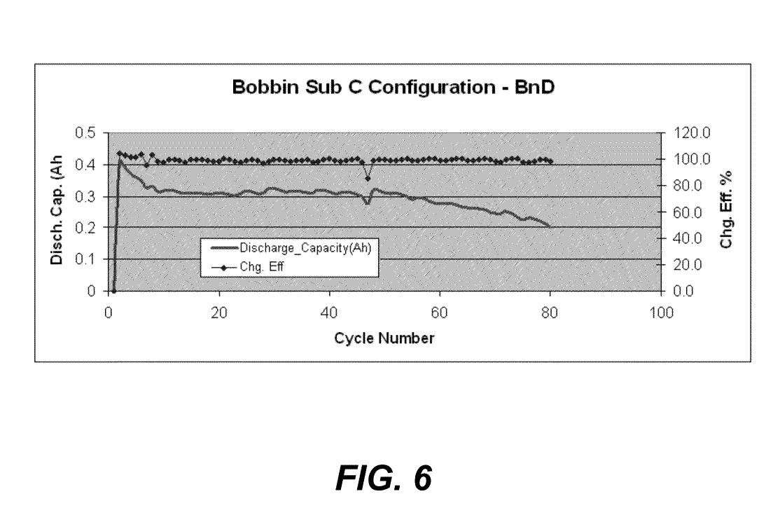

FIG. 6 shows cycling data and charge to discharge capacity ratio up to 80 cycles for a pencil battery in accordance with the embodiments herein. The cell exhibited a charge to discharge capacity ratio close to 1 that was constant over 80 cycles indicating that at no time did the cell develop a soft short. The charge rate was 600 mA and the discharge rate was 400 mA.

Conclusion

Although only a few implementations have been presented for the sake of clarity, various design alternatives may be implemented. Therefore, the present examples are to be considered as illustrative and not restrictive, and the implementations are not to be limited to the details given herein, but may be modified within the scope of the invention. It will be apparent to one of ordinary skill in the art that certain changes and modifications can be practiced within the scope of the appended claims.

What is claimed is:

1. A rechargeable battery comprising:
a) a hollow cylindrical positive electrode comprising nickel hydroxide;
b) a gelled negative electrode comprising at least one of zinc and a zinc compound;
c) a separator interposed between an interior surface of the hollow cylindrical positive electrode and the gelled negative electrode;
d) a negative electrode current collector in the gelled negative electrode;
(e) a battery can housing the cylindrical positive electrode, the gelled negative electrode, the separator and the negative electrode current collector, wherein the battery can comprises a first end that is open and a second end; and
(f) a positive cap affixed to the second end of the battery can.

2. The rechargeable battery of claim 1, wherein the hollow cylindrical positive electrode comprises a plurality of stacked annular pellets.

3. The rechargeable battery of claim 1, wherein the hollow cylindrical positive electrode comprises nickel hydroxide and cobalt metal and/or a cobalt compound.

4. The rechargeable battery of claim 3, wherein the hollow cylindrical positive electrode comprises a first conductive agent comprising at least one of nickel, carbon, conductive polymers and conductive ceramics.

5. The rechargeable battery of claim 4, wherein the first conductive agent is in the form of a powder, foam, fiber or combinations thereof.

6. The rechargeable battery of claim 3, wherein the hollow cylindrical positive electrode comprises a binder comprising at least one of polytetrafluoroethylene (PTFE), cellulose, carboxymethylcellulose (CMC), and HPMC.

7. The rechargeable battery of claim 3, wherein the hollow cylindrical positive electrode comprises an irrigative agent comprising at least one of alumina, cellulose and a hydrophilic material.

8. The rechargeable battery of claim 1, wherein the gelled negative electrode comprises a solid mixture combined with a gelling agent, an alkali electrolyte and a second conductive agent.

9. The rechargeable battery of claim 8, wherein the solid mixture comprises zinc and zinc oxide.

10. The rechargeable battery of claim 9, wherein the solid mixture also comprises at least one of alumina, cellulose and newsprint.

11. The rechargeable battery of claim 8, wherein the second conductive agent comprises up to 30% of the volume of the gelled negative electrode.

12. The rechargeable battery of claim 8, wherein the separator comprises a bilayer laminate comprising a barrier layer and a wicking layer.

13. The rechargeable battery of claim 12, wherein the barrier layer comprises a microporous membrane between about 25 μm and 75 μm thick.

14. The rechargeable battery of claim 13, wherein the wicking layer is between about 25 μm and 200 μm thick.

15. The rechargeable battery of claim 1, wherein the negative electrode current collector comprises at least one of brass, copper and steel; optionally comprising a hydrogen evolution inhibitor.

16. The rechargeable battery of claim 15, wherein the hydrogen evolution inhibitor comprises at least one of tin, lead, bismuth, silver, indium and carbon.

17. The rechargeable battery of claim 15, wherein the negative electrode current collector comprises a surface area enhancing geometrical element.

18. The rechargeable battery of claim 1, further comprising a negative electrode terminal plate electrically connected to the negative electrode current collector.

19. The rechargeable battery of claim 1, wherein the ratio of the length of the rechargeable battery to the diameter of the rechargeable battery is between about 1.5:1 and about 20:1.

20. The rechargeable battery of claim 1, wherein the battery can has a form factor conforming to the size and shape of a standard battery size selected from the group consisting of AAA, AA, C, D and sub-C.

21. The rechargeable battery of claim 1, further comprising an identification tag that uniquely identifies the rechargeable battery and allows its number of charge or discharge cycles to be monitored.

22. The rechargeable battery of claim 1, wherein the second end of the can contains a vent hole.

23. The rechargeable battery of claim 1, further comprising a negative collector disc in electrical communication with the gelled negative electrode and having a substantially flat surface and serving as a negative terminal for the rechargeable battery.

24. The rechargeable battery of claim 1, where in the positive cap comprises a vent hole.

25. The rechargeable battery of claim 19, wherein the relative ratio of the diameter of the hollow of the hollow cylindrical positive electrode to the diameter of the rechargeable battery is between about 0.4 and about 0.95.

26. The rechargeable battery of claim 25, wherein the annulus of the hollow cylindrical positive electrode is between about 1.5 mm and 2.5 mm thick.

27. A rechargeable battery comprising:
a) a hollow cylindrical positive electrode comprising (i) nickel hydroxide and/or nickel oxyhydroxide, and (ii) cobalt metal and/or a cobalt compound;
b) a gelled negative electrode comprising between 0% and about 30% by weight of zinc, between about 65% and 100% by weight of zinc oxide, a gelling agent, an alkaline electrolyte, and optionally at least one of carbon, cellulose, titanium nitride and alumina;
c) a substantially tubular separator interposed between the hollow cylindrical positive electrode and the gelled negative electrode; and
d) a negative electrode current collector in the gelled negative electrode;
wherein the rechargeable battery is capable of between about 25 and 1000 cycles from a fully charge state to a fully discharged state at a discharge rates of about 0.5 C or greater.

28. The rechargeable battery of claim 27, further comprising a battery can configured to a commercially available size selected from the group consisting of AAA, AA, C, D and sub-C.

29. The rechargeable battery of claim 28, wherein the annulus of the hollow cylindrical positive electrode is between about 1 mm and about 3 mm thick.

30. The rechargeable battery of claim 27, wherein the hollow cylindrical positive electrode further comprises nickel and/or carbon.

31. A method of making a rechargeable battery assembly, the method comprising:
a) introducing a hollow cylindrical positive electrode comprising nickel hydroxide into a can;
b) introducing a separator tube, into the hollow of the hollow cylindrical positive electrode;
c) introducing a gelled negative electrode having at least one of zinc and a zinc compound into the separator tube; and
d) inserting a negative electrode current collector inserted into the gelled negative electrode.

32. The method of claim 31, wherein the gelled negative electrode is formed in situ in the separator.

33. The method of claim 31, wherein the hollow cylindrical electrode mixture comprises a stack of annular pellets.

34. The method of claim 31, wherein the topmost portion of the separator tube is above the topmost portion of the hollow cylindrical positive electrode, which in turn is above the topmost portion of the gelled negative electrode.

35. The method of claim 56, wherein the negative electrode current collector is attached to a closure used to seal the can and complete the rechargeable battery assembly.
